(19) United States
(12) Patent Application Publication
(10) Pub. No.: US 2025/0181894 A1
(43) Pub. Date: Jun. 5, 2025

(54) ADAPTIVE PRECISION FOR DEEP NEURAL NETWORK MODELS

(71) Applicant: HEWLETT PACKARD ENTERPRISE DEVELOPMENT LP, Spring, TX (US)

(72) Inventors: EITAN FRACHTENBERG, Portland, OR (US); Paolo Faraboschi, Milpitas, CA (US); Cong Xu, Milpitas, CA (US); Dejan S. Milojicic, Milpitas, CA (US)

(21) Appl. No.: 18/527,627

(22) Filed: Dec. 4, 2023

(51) Int. Cl. G06N 3/045; G06N 3/08

(52) U.S. Cl. CPC G06N 3/045; G06N 3/08

(57) ABSTRACT

Examples of the presently disclosed technology provide computerized systems and methods for dynamically adjusting amounts of precision (i.e., numbers of bits) used to represent and store individual weights of a neural network model (e.g., a DNN model) in response to training. Examples can use various heuristics to intelligently determine these individualized, and dynamic precision levels. For instance, a heuristic may include one or more of: (1) a measurement quantifying a magnitude of a respective weight's influence on output of the neural network model during a most recent set of training iterations (weights having relatively higher influence can be represented using higher precision); and (2) a measurement quantifying a magnitude of the respective weight's fluctuations in value during the most recent set of training iterations (weights having relatively smaller fluctuations in value can be represented using higher—i.e., more granular—precision).

### BACKGROUND

Machine learning models may comprise algorithm-based computer programs trained to recognize patterns in data and make predictions and/or classifications based on such learned pattern recognition.

A neural network model (sometimes referred to as an artificial neural network) is a type of machine-learning model inspired by structure of the human brain. For example, a neural network model may comprise a series of algorithms trained to recognize patterns in data in a manner that mimics how a human brain works. For conceptualization, neural network models are sometimes described as being composed of interconnected “neurons” arranged into layers (much like in a human brain). Here, each neuron may represent an algorithm that receives one or more inputs and produces an output. For example, a common neuron-based conceptualization describes a neural network model in terms of: (a) an input layer of neurons that receives input data and produces outputs; (b) one or more hidden layers of neurons that receive weighted outputs from the input layer (or in the case of multiple hidden layers, weighted outputs from a previous hidden layer) and produce their own outputs; and (c) an output layer of neurons that receives weighted outputs from the last hidden layer and produces an output prediction/classification. In such a neuron-based conceptualization, a respective neuron is generally connected with one or more neurons in other layer(s). For example, a respective neuron in a first hidden layer may be connected with, and receive weighted outputs from, one or more neurons in an input layer. Similarly, one or more neurons in a second hidden layer may be connected with, and receive weighted outputs from, the respective neuron in the first hidden layer. As alluded to above, each “connection” (sometimes referred to as a synapse) between two neurons is associated with a numerical weight that is multiplied by an output of one neuron to produce the input received by the other neuron. For example, a connection between a first neuron of the input layer and the respective neuron of the first hidden layer may have a first weight. This first weight is multiplied by output of the first neuron of the input layer to produce an input received by the respective neuron of the first hidden layer. Relatedly, a connection between the respective neuron of the first hidden layer and a first neuron of the second hidden layer may have a second weight. This second weight is multiplied by an output of the respective neuron of the first input layer to produce an input received by the first neuron of the second hidden layer. In this neuron-based conceptualization, the connection weights (sometimes referred to herein more simply as weights) of a neural network model are modified/tuned in response to training. In other words, by dynamically modifying its connection weights during training, a neural network model can “learn” to produce more accurate predictions/classifications.

While the above-described neuron-based conceptualization can be helpful for understanding neural network models, another representation/conceptualization for neural network models involves weight matrices and matrix multiplication. In this matrix-based representation, weights of a neural network model correspond to elements of weight matrices. The number of weight matrices and/or matrix-multiplication operations for a neural network model can correspond with the number of layers of the neural network model. For example, a simple three-layer neural network model may comprise: (a) a first weight matrix that is multiplied by an input vector to produce a first output vector (this first weight matrix is analogous to the connection weights between an input layer of neurons and a hidden layer of neurons); and (b) a second weight matrix that is multiplied by the first output vector to produce a second output vector (this second weight matrix is analogous to the connection weights between the hidden layer of neurons and an output layer of neurons). This second output vector may embody (or otherwise be used to make) the ultimate prediction/classification of the neural network model. Referring back to the neuron-based conceptualization, the number of neurons of an input layer and first hidden layer of a neural network model may correspond with the dimensions (i.e., the number of columns and rows respectively) of a weight matrix that represents their connection weights. Likewise, the number of neurons of a final hidden layer and an output layer of the neural network model may correspond with the dimensions of a weight matrix that represents their connection weights. As alluded to above, the weights/elements of weight matrices of the neural network model are modified/tuned in response to training.

### BRIEF DESCRIPTION OF THE DRAWINGS

The present disclosure, in accordance with one or more various examples, is described in detail with reference to the following figures. The figures are provided for purposes of illustration only and merely depict examples.

FIGS. 1A-1C illustrate example neuron-based conceptualizations of a neural network model, in accordance with one or more examples.

FIG. 2 illustrates an example computing component for storing weights of a neural network model using different amounts of precision, in accordance with one or more examples.

FIG. 3 illustrates an example computing system for storing weights of a neural network model using different amounts of precision, in accordance with one or more examples.

FIG. 4 depicts an example computing system that can be used to dynamically adjust amounts of precision used to represent individual weights of a neural network in response to training, in accordance with one or more examples.

FIG. 5 depicts an example flow diagram that can be used to dynamically adjust amounts of precision used to represent individual weights of a neural network in response to training, in accordance with one or more examples.

The figures are not exhaustive and do not limit the present disclosure to the precise form disclosed.

### DETAILED DESCRIPTION

Deep neural network (DNN) models (sometimes referred to as deep learning neural networks) may refer to neural network models with more than one “hidden layer.” In other words, in terms of a matrix-based representation, DNN models may refer to neural network models having three or more weight matrices/matrix multiplications. DNN models are popular in various applications including generative artificial intelligence (AI) due to their sophisticated/advanced predictive capabilities. In general, as the number of layers of a neural network model increases, so does its learning capabilities. Accordingly, DNN models can be enormous, sometimes comprising billions of weights, and relying on thousands/millions of matrix multiplications to produce predictions/classifications. However, such size comes at a serious monetary and resource cost.

For example, the processing and memory hardware required to implement large DNN models can be substantial. Accordingly, DNN models are often implemented across many physical computing units (e.g., general processing units (GPUs)). Many-physical computing unit implementations can significantly increase monetary and resource costs, as well as processing times. For example, where the weights of a DNN model are stored across many physical computing units (e.g., GPUs and/or hardware accelerators), implementing the DNN model generally requires a model serving system that requests weights from the many physical computing units as needed (e.g., for matrix multiplications) during run-time. This requesting/movement of weights across many physical computing units can add to the already enormous consumption of processing resources and processing time required to implement the DNN model.

In general, monetary and resource costs associated with implementing a neural network model (e.g., a DNN model) can be reduced by using lower precision (i.e., a lower number of memory bits) to represent weights of the neural network model. This is in part because with lower precision, a greater number of weights can be stored in a given (physical or logical) segment of memory hardware. In other words, the amount of memory hardware required to store neural network model weights can be reduced by storing/representing neural network model weights with lower precision. A reduction in the amount of memory hardware required to store neural network model weights can reduce monetary and resource costs for implementing the neural network model significantly. For example, the weights of the neural network model can be stored across fewer physical computing units, reducing: (1) memory hardware material costs; and (2) data latencies associated with requesting and moving weights from different physical computing units as needed (e.g., for matrix multiplication) during run-time. Related to above, matrix multiplications can generally be performed faster with lower precision weights, which can help reduce processing times for neural network models in some cases.

However, representing neural network model weights with lower precision generally reduces model and training quality. For example, with lower precision weights, a neural network model may not achieve weight convergence (as used herein, weight convergence may refer to the convergence of individual weight values for a neural network model that generally signals training is complete). By contrast, neural network models with relatively higher precision weights are more likely to converge, and also tend to converge more quickly (e.g., with fewer training iterations). However (and as described above), higher-precision weight representation/storage requires increasing amounts of memory hardware-which comes with all the monetary and resource costs described above.

In summary, there is a need for an innovative technology that intelligently balances the competing interests of memory hardware resource conservation (typically achieved by representing/storing neural network model weights with relatively lower precision) and improved model/training quality (typically achieved by representing/storing neural network model weights with relatively higher precision).

Against this backdrop, examples of the presently disclosed technology provide computerized systems and methods for dynamically adjusting amounts of precision (i.e., numbers of bits) used to represent and store individual weights of a neural network model (e.g., a DNN model) in response to training. Examples can use various heuristics to intelligently determine these individualized, and dynamic precision levels. For instance, a heuristic may include one or more of: (1) a measurement quantifying a magnitude of a respective weight's influence on output of the neural network model during a most recent set of training iterations (weights having relatively higher influence can be represented using higher precision); and (2) a measurement quantifying a magnitude of the respective weight's fluctuations in value during the most recent set of training iterations (weights having relatively smaller fluctuations in value can be represented using higher—i.e., more granular-precision).

Examples improve upon potential alternative technologies that simply: (a) modify weight precision statically (e.g., before training); and/or (b) adjust precision for all the weights of a neural network model uniformly. In other words, by making dynamic, individualized precision adjustments for neural network model weights, examples can better balance the above-described competing interests of memory hardware resource conservation (typically achieved by representing/storing neural network model weights with relatively lower precision) and improved model/training quality (typically achieved by representing/storing neural network model weights with relatively higher precision). Relatedly, examples improve the functioning of computer memory systems/technologies used to implement neural network models by providing methodologies for storing neural network model weights more efficiently in computer memory hardware.

Such improvements leverage an intelligent insight that higher precision for certain weights of a neural network model (e.g., those weights that had a relatively greater influence on output of the neural network model during a most recent set of training iterations and/or those weights that had relatively smaller fluctuations in values during the most recent set of training iterations) improve/impact weight convergence more than would higher precision for other weights of the neural network model (e.g., those weights that had a relatively smaller influence on output of the neural network model during the most recent set of training iterations and/or those weights that had relatively higher fluctuations in values during the most recent set of training iterations). Leveraging this insight to define a heuristic for dynamically determining an amount of precision used to represent/store a respective weight of the neural network model, examples can better balance the above-described competing interests of memory hardware resource conservation (typically achieved by representing/storing neural network model weights with relatively lower precision) and improved model/training quality (typically achieved by representing/storing neural network model weights with relatively higher precision).

For example, a system of the presently disclosed technology can: (1) responsive to completion of a first set of training iterations for a neural network model, first categorize, according to a heuristic, weights of the neural network model into a first memory block and a second memory block; (2) first store individual weights first-categorized to the first memory block using a first number of memory bits; (3) first store individual weights first-categorized to the second memory block using a second number of memory bits, wherein the first number of memory bits is smaller than the second number of memory bits; (4) responsive to completion of a second set of training iterations for the neural network model having the first-stored weights, second categorize, according to the heuristic, the first-stored weights of the neural network model into the first memory block and the second memory block; (5) second store individual weights second-categorized to the first memory block using the first number of memory bits; and (6) second store individual weights second-categorized to the second memory block using the second number of memory bits. As alluded to above, the heuristic may comprise one or more of: (1) a measurement quantifying a magnitude of a respective weight's influence on output of the neural network model during a most recent set of training iterations (weights having relatively higher influence can be represented using the second—i.e., higher-number of memory bits); and (2) a measurement quantifying a magnitude of the respective weight's fluctuations in value during the most recent set of training iterations (weights having relatively smaller fluctuations in value can be represented using the second—i.e., higher/more granular-number of memory bits).

In certain examples, first storing the individual weights first-categorized to the first memory block may comprise first storing the individual weights first-categorized to the first memory block in individual (physical or logical) sub-segments of a first (physical or logical) segment of memory hardware. Here a respective sub-segment of the first segment of memory hardware may comprise the first number of memory bits. Relatedly, first storing the individual weights first-categorized to the second memory block may comprise first storing the individual weights first-categorized to the second memory block in individual (physical or logical) sub-segments of a second (physical or logical) segment of memory hardware. Here, a respective sub-segment of the second segment of memory hardware may comprise the second number of memory bits. In some examples, the first segment of memory hardware may be implemented on a first streaming multiprocessor (SM) of a general processing unit (GPU) and the second segment of memory hardware may be implemented on a second SM of the GPU (or another GPU). By grouping weights of similar precision in the same (physical or logical) memory unit (i.e., the respective segments of memory hardware/the respective SMs), the system can reduce data latencies associated with moving weights between different memory units at run-time. Relatedly, the system can improve programming and processing ease/efficiency by having a given (physical or logical) computing unit perform matrix operations involving weights having a common precision. For example, the system can first perform intra-memory block matrix operations (i.e., matrix operations involving weights stored within the same memory block/segment of memory hardware). Then, responsive to completion of the intra-memory block matrix operations, the system can perform inter-memory block matrix operations (i.e., matrix operations between weights categorized into the first memory block/stored in the first segment of memory hardware and weights categorized into the second memory block/stored in the second segment of memory hardware). This organized sequence of performing matrix operations may be more efficient (i.e., result in less weight movement across units/segments of memory hardware) than an alternative approach that performs matrix operations involving weights stored across different segments of memory hardware and/or different physical computing units in a less organized manner. As alluded to above, improving matrix operation efficiency can improve processing times, and in some case reduce power consumption and monetary costs.

Examples of the presently disclosed technology will now be described in conjunction with the following figures.

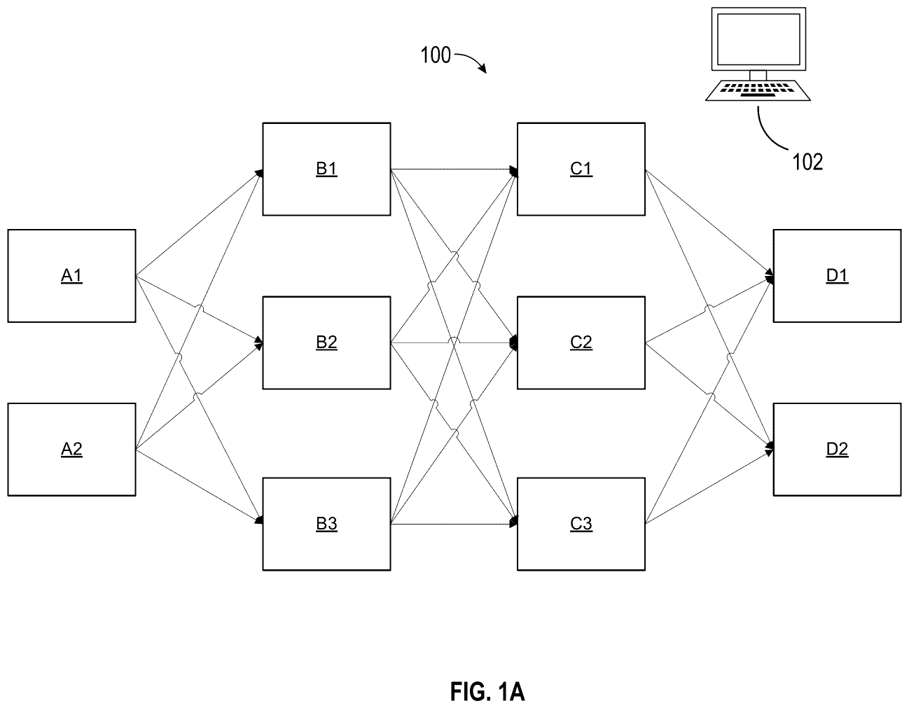

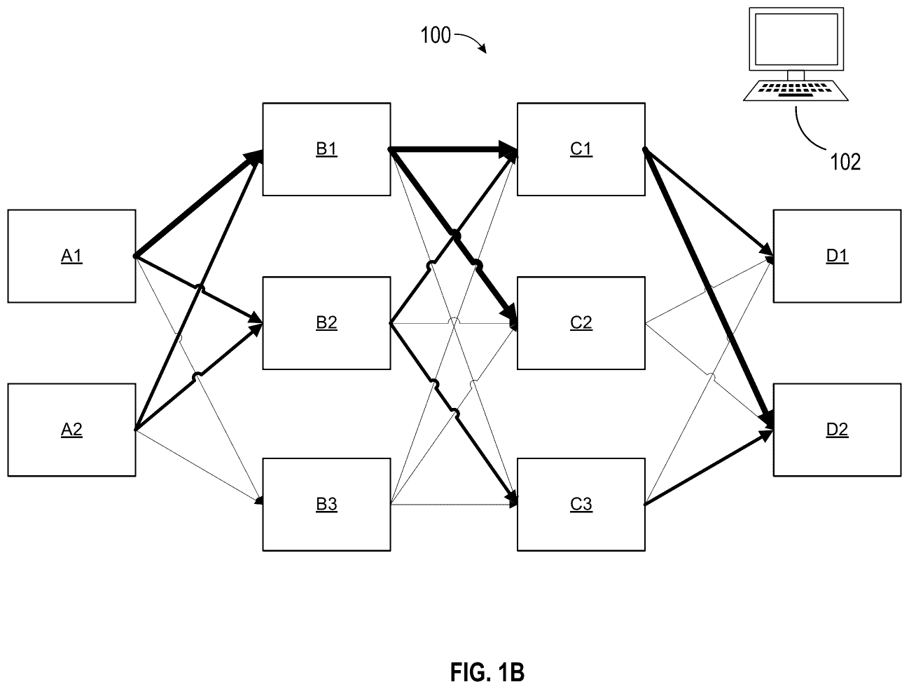

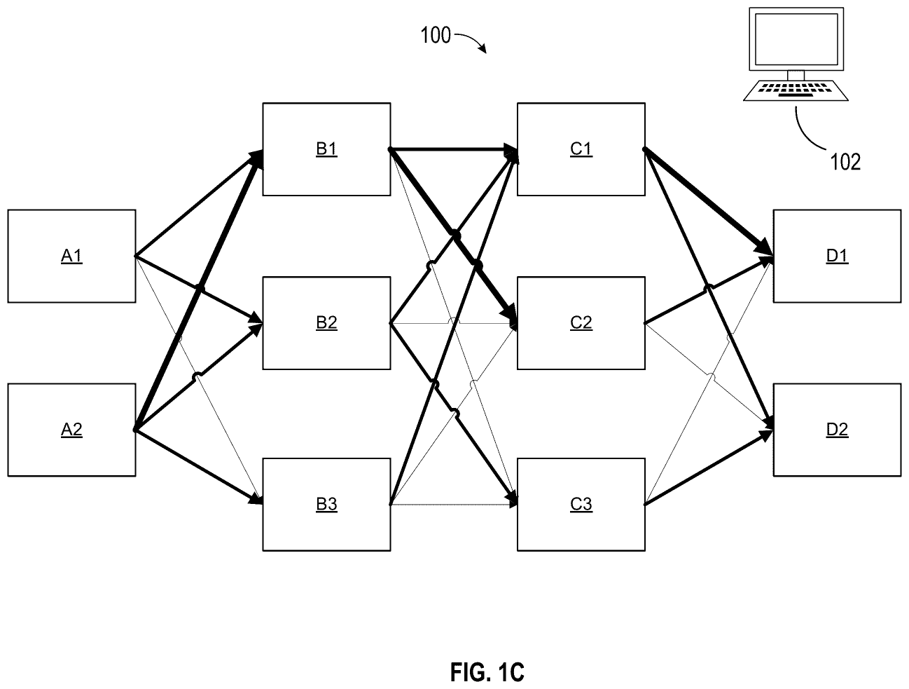

FIGS. 1A-1C illustrate example neuron-based conceptualizations of a neural network model 100, in accordance with various examples of the presently disclosed technology.

As depicted, the neuron-based conceptualization of neural network model 100 comprises four layers of “neurons.” An input layer of neural network model 100 comprises neurons A1 and A2. A first hidden layer of neural network model 100 comprises neurons B1, B2, and B3. A second hidden layer of neural network model 100 comprises neurons C1, C2, and C3. An output layer of neural network model 100 comprises neurons D1 and D2.

As alluded to above, each neuron of neural network model 100 may represent an algorithm that receives one or more inputs, and produces an output. For example, neurons A1 and A2 of the input layer can receive inputs to neural network model 100 (e.g., numerical vectors that represent input images to be classified) and produce outputs. Neurons B1-B3 of the first hidden layer can receive weighted outputs from neurons A1 and A2 of the input layer and produce their own outputs. Relatedly, neurons C1-C3 of the second hidden layer can receive weighted outputs from neurons B1-B3 of the first hidden layer and produce their own outputs. Finally, neurons D1-D2 of the output layer can receive weighted outputs from neurons C1-C3 of the second hidden layer and produce their own outputs. The outputs of neurons D1-D2 (e.g., a numerical vector) may embody (or otherwise be used to make) an ultimate prediction/classification of neural network model 100.

In the neuron-based conceptualization of neural network model 100, each neuron is connected with one or more neurons in other layer(s). For example, neuron B1 of the first hidden layer is connected with, and receives weighted outputs from, neurons A1 and A2 of the input layer. Similarly, neurons C1-C3 are connected with, and receive weighted outputs from, neuron B1. As alluded to above, each “connection” (sometimes referred to as a synapse) between two neurons is associated with a numerical weight that is multiplied by an output of one neuron to produce the input received by the other neuron. In FIGS. 1A-1C, connections between neurons are depicted by the arrows. For example, a connection A1→B1 connects neurons A1 and B1. Likewise, a connection B3→C1 connects neurons B3 and C1.

As alluded to above, each connection between neurons may have a respective weight. For example, connection A1→B1 may have a first weight, a connection A1→B2 may have a second weight, a connection A1→B3 may have a third weight, etc. A respective weight is multiplied by output of one neuron to produce an input received by the other neuron. For example, the first weight of connection A1→B1 is multiplied by the output of neuron A1 to produce the input received by neuron B1. Likewise, the second weight of connection A1→B2 is multiplied by the output of neuron A1 to produce the input received by neuron B2.

As alluded to above, in the neuron-based conceptualization of FIGS. 1A-1C, the connection weights (sometimes referred to herein more simply as weights) of neural network model 100 are modified/tuned in response to training. In other words, by dynamically modifying its connection weights during training, neural network model 100 can “learn” to produce more accurate predictions/classifications.

While the neuron-based conceptualization of FIGS. 1A-1C can be helpful for understanding neural network models, another representation/conceptualization of neural network models involves weight matrices and matrix multiplication. In a matrix-based representation, weights of neural network model 100 correspond to elements of weight matrices. The number of weight matrices and/or matrix multiplication operations for neural network model 100 can correspond with the number of layers of neural network model 100. For example, neural network model 100 may comprise: (a) a first weight matrix that is multiplied by an input vector to produce a first output vector (this first weight matrix may be analogous to the connection weights between the input layer and the first hidden layer of neural network model 100 in FIGS. 1A-1C); (b) a second weight matrix that is multiplied by the first output vector to produce a second output vector (this second weight matrix may be analogous to the connection weights between the first hidden layer and the second hidden layer of neural network model 100 in FIGS. 1A-1C); and (c) a third weight matrix that is multiplied by the second output vector to produce a third output vector (this third weight matrix may be analogous to the connection weights between the second hidden layer and the output layer of neural network model 100 in FIGS. 1A-1C). This third output vector may embody (or otherwise be used to make) the ultimate prediction/classification of neural network model 100. Referring back to the neuron-based conceptualization of FIGS. 1A-1C, the number of neurons of the input layer (i.e., two) and the first hidden layer (i.e., three) of neural network model 100 may correspond with the dimensions (i.e., the number of columns and rows respectively) of the first weight matrix that represents/corresponds with their connection weights. Likewise, the number of neurons of the first hidden layer (i.e., three) and the second hidden layer of neural network model 100 may correspond with the dimensions of the second weight matrix that represents/corresponds with their connection weights. Similarly, the number of neurons of the second hidden layer (i.e., three) and the output layer (i.e., two) of neural network model 100 may correspond with the dimensions of the third weight matrix that represents/corresponds with their connection weights. As alluded to above, the weights/elements of weight matrices of neural network model 100 are modified/tuned in response to training.

Because neural network model 100 comprises more than one “hidden layer,” it may be referred to as a deep neural network (DNN) model. However, it should be understood that neural network model 100 is a significantly simplified version of a typical DNN model. As alluded to above, many DNN models are enormous, often comprising billions of weights, and relying on thousands/millions of matrix multiplications to produce predictions/classifications. However (and as described above), such size comes at a serious monetary and resource cost.

For example, the processing and memory hardware required to implement large DNN models can be substantial. Accordingly, DNN models are often implemented across many physical computing units (e.g., general processing units (GPUs)). Many-physical computing unit implementations can significantly increase monetary and resource costs, as well as processing times. For example, where the weights of a DNN model are stored across many physical computing units (e.g., GPUs and/or hardware accelerators), implementing the DNN model generally requires a model serving system that requests weights from the many physical computing units as needed (e.g., for matrix multiplications) during run-time. This requesting/movement of weights across many physical computing units can add to the already enormous consumption of processing resources and processing time required to implement the DNN model.

In general, monetary and resource costs associated with implementing a neural network model (e.g., a DNN model) can be reduced by using lower precision (i.e., a fewer number of memory bits) to represent weights of the neural network model. This is in part because with lower precision, a greater number of weights can be stored in a given (physical or logical) segment of memory hardware. In other words, the amount of memory hardware required to store neural network model weights can be reduced with lower precision. A reduction in the amount of physical memory hardware required to store the weights of the neural network model can reduce monetary and resource costs for implementing the neural network model significantly. For example, the weights of the neural network model can be stored across fewer physical computing units, reducing: (1) memory hardware material costs; and (2) data latencies associated with requesting and moving weights from different physical computing units as needed (e.g., for matrix multiplication) during run-time. Related to above, matrix multiplications can generally be performed faster with lower precision weights, which can help reduce processing times for neural network models in some cases.

However, representing weights of a neural network model with lower precision generally reduces model and training quality. For example, with lower precision weights, a neural network model may never achieve weight convergence (as used herein, weight convergence may refer to the convergence of individual weight values for a neural network model that generally signals training is complete). By contrast, neural network models with relatively higher precision weights are more likely to converge, and also tend to converge more quickly (e.g., with fewer training iterations). However (and as described above), higher precision weight representation/storage requires increasing amounts of memory hardware-which comes with all the monetary and resource costs described above.

In summary, there is a serious need for an innovative technology that intelligently balances the competing interests of memory hardware resource conservation (typically achieved by representing/storing neural network model weights with relatively lower precision) and improved model/training quality (typically achieved by representing/storing neural network model weights with relatively higher precision).

Against this backdrop (and as alluded to above), examples of the presently disclosed technology provide computerized systems and methods for dynamically adjusting amounts of precision (i.e., numbers of bits) used to represent and store individual weights of a neural network model (e.g., weights of neural network model 100, or more pertinently, weights of a much larger version of neural network model 100) in response to training. Examples can use various heuristics to intelligently determine these individualized, and dynamic precision levels. For instance, a heuristic may include one or more of: (1) a measurement quantifying a magnitude of a respective weight's influence on output of the neural network model during a most recent set of training iterations (weights having relatively higher influence can be represented using higher precision); and (2) a measurement quantifying a magnitude of the respective weight's fluctuations in value during the most recent set of training iterations (weights having relatively smaller fluctuations in value can be represented using higher—i.e., more granular-precision).

Examples improve upon potential alternative technologies that simply: (a) modify weight precision statically (e.g., before training); and/or (b) adjust precision for all the weights of a neural network model uniformly. In other words, by making dynamic, individualized precision adjustments for neural network model weights, examples can better balance the above-described competing interests of memory hardware resource conservation (typically achieved by representing/storing neural network model weights with relatively lower precision) and improved model/training quality (typically achieved by representing/storing neural network model weights with relatively higher precision). Relatedly, examples improve the functioning of computer memory systems/technologies used to implement neural network models by providing methodologies for storing neural network model weights more efficiently in computer memory hardware.

Such improvements leverage an intelligent insight that higher precision for certain weights of a neural network model (e.g., those weights that had a relatively greater influence on output of the neural network model during a most recent set of training iterations and/or those weights that had relatively smaller fluctuations in values during the most recent set of training iterations) improve/impact weight convergence more than would higher precision for other weights of the neural network model (e.g., those weights that had a relatively smaller influence on output of the neural network model during the most recent set of training iterations and/or those weights that had relatively higher fluctuations in values during the most recent set of training iterations). Leveraging this insight to define a heuristic for dynamically determining an amount of precision used to represent/store a respective weight of the neural network model, examples can better balance the above-described competing interests of memory hardware resource conservation (typically achieved by representing/storing neural network model weights with relatively lower precision) and improved model/training quality (typically achieved by representing/storing neural network model weights with relatively higher precision).

For example (and referring again to FIG. 1A), a system 102 of the presently disclosed technology may apply a first set of training iterations to neural network model 100. During this first set of training iterations, a first (e.g., low) number of memory bits may be used to represent/store each weight of neural network model 100.

Responsive to the first set of training iterations system 102 can compute a heuristic for each weight of neural network model 100. For example, system 102 can compute: (1) a magnitude of each weight's influence on output of neural network model 100 during the first set of training iterations (as alluded to above, weights having relatively higher magnitudes of influence are better candidates for relatively higher precision representation/storage); and (2) a magnitude of each weight's fluctuations in value during the first set of training iterations (as alluded to above, weights having relatively smaller fluctuations in values are better candidates for relatively higher precision representation/storage). System 102 can then use these computations to compute the heuristic (e.g., a number) for first categorizing each weight of neural network model 100 into a first memory block (e.g., a first logical or physical segment of memory that represents/stores individual weights using a first number of memory bits), a second memory block (e.g., a second logical or physical segment of memory that represents/stores individual weights using a second number of memory bits), or a third memory block (e.g., a third logical or physical segment of memory that represents/stores individual weights using a third number of memory bits). Here, system 102 can first categorize weights with heuristic values in a first range of values to the first memory block. Relatedly, system 102 can first categorize weights with heuristic values in a second range of values to the second memory block. Similarly, system 102 can first categorize weights with heuristic values in a third range of values to the third memory block. Here, the first-third ranges of values may be contiguous with each other. Relatedly, the first range may have the smallest values for the heuristic, the second range may the second smallest values for the heuristic, and the third range may have the highest values for the heuristic. Here it should be understood that the above-described heuristic computations, memory block arrangement, and categorization approach are merely illustrative examples. In general, various heuristics and heuristic computations, two or more memory blocks, and various categorization approaches may be used.

As used herein, a set of training iterations may refer to a specific (in some cases, pre-determined) number of forward and/or backward passes of training data through a neural network model during training. During each training iteration, the neural network model may process a batch of data, compute loss and/or error based on predicted and actual outcomes, and update its weights using an optimization algorithm. The number of training iterations in a set can be determined based on various factors, such as the size of a training dataset, batch size, etc.

As alluded to above, prior to a second set of training iterations, system 102 can store the first-categorized weights of neural network model 100 according to their respective memory blocks. For example, individual weights first-categorized to the first memory block can each be stored using the first (e.g., low) number of memory bits. Individual weights first-categorized to the second memory block can each be stored using the second (e.g., medium) number of memory bits. Individual weights first-categorized to the third memory block can each be stored using the third (e.g., high) number of memory bits. In the specific example of FIGS. 1A-1C the first number of memory bits may correspond with a relative low precision, the second number of memory bits may correspond with a relative medium precision, and the third number of memory bits may correspond with a relative high precision.

The thickness of the arrows depicting connections of neural network model 100 in FIGS. 1A-1C provides a visual representation for the precision level used to a respective weight associated with a respective connection. The thinnest arrows correspond with the first (i.e., low) number of memory bits. The medium-thickness arrows correspond with the second (i.e., medium) number of memory bits. The thickest arrows correspond with the third (i.e., high) number of memory bits.

As depicted in FIG. 1A, during the first set of training iterations each weight was represented/stored using the first (e.g., low) number of memory bits. However, as depicted in FIG. 1B, during the second set of training iterations system 102 represented/stored certain bits with higher precision. Namely, system 102 stored individual weights associated with connections A1→B2, A2→B1, C1→D1, and C3→D2 with the second (i.e., medium) number of memory bits. Relatedly, system 102 stored individual weights associated with connections A1→B1, B1→C1, and C1→D2 with the third (i.e., high) number of memory bits. As alluded to above, these individualized precision categorizations made dynamically during training can better balance the above-described competing interests of memory hardware resource conservation and improved model/training quality than potential alternative technologies which merely: (a) modify weight precision statically (e.g., before training); and/or (b) adjust precision for all the weights of a neural network model uniformly.

As examples of the presently disclosed technology are designed in appreciation of, the values of the heuristic for individual weights of neural network model 100 may evolve during training. To account for this dynamism, system 102 can compute the heuristic for each weight of neural network model 100 iteratively/repetitively during training—for example, after each set of training iterations. Accordingly, responsive to the second set of training iterations, system 102 can compute the heuristic for each weight of neural network model 100 again. Based on these heuristic computations, system 102 can second categorize individual weights of neural network model 100 into the first-third memory blocks in the same/similar manner as described above. Then, prior to a third set of training iterations, system 102 can store the second-categorized weights of neural network model 100 according to their respective memory blocks. For example, individual weights second-categorized to the first memory block can each be stored using the first (e.g., low) number of memory bits. Individual weights second-categorized to the second memory block can each be stored using the second (e.g., medium) number of memory bits. Individual weights second-categorized to the third memory block can each be stored using the third (e.g., high) number of memory bits. As depicted in FIG. 1C, this may involve adjusting storage precision for individual weights associated with connections A1→B1, A2→B1, A2→B2, A2→B3, B1→C1, B3→C1, C1→D1, C1→D2 and C2→D1 (see e.g., the changes in arrow thicknesses for these connections when going from FIG. 1B to FIG. 1C).

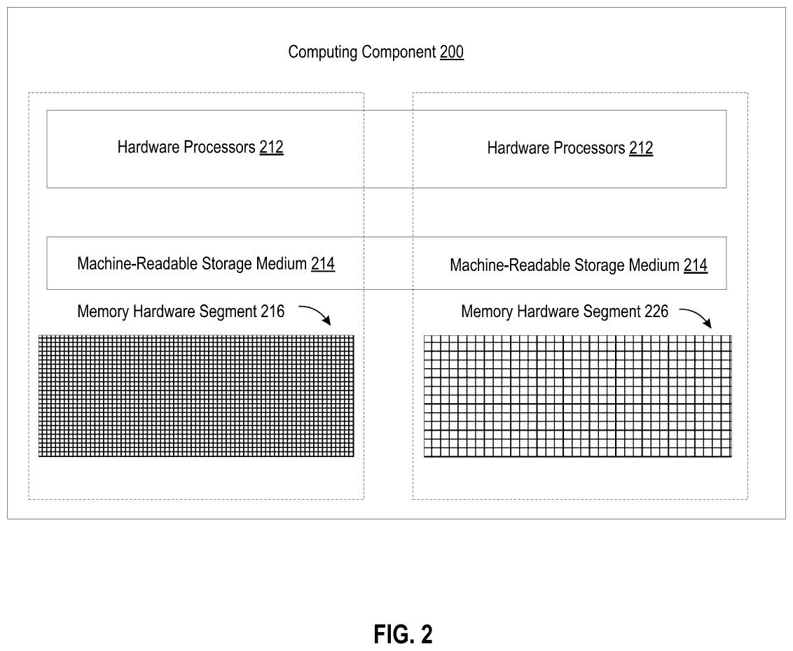

FIG. 2 illustrates an example computing component 200 for storing weights of a neural network model using different amounts of precision, in accordance with various examples of the presently disclosed technology. In certain examples, computing component 200 may be implemented on system 102 of FIG. 1.

Computing component 200 may be, for example, a server computer, a controller, a general processing unit (GPU), or any other similar computing component capable of processing and storing data. In the example implementation of FIG. 2, computing component 200 includes hardware processors 212, machine-readable storage medium 214, memory hardware segment 216, and memory hardware segment 226.

Hardware processors 212 may comprise one or more central processing units (CPUs), semiconductor-based microprocessors, and/or other hardware devices suitable for retrieval and execution of instructions stored in machine-readable storage medium 214. Hardware processors 212 may fetch, decode, and execute instructions, such as instructions for storing weights of a neural network model (e.g., neural network model 100) using different amounts of precision. As an alternative or in addition to retrieving and executing instructions, hardware processors 212 may include one or more electronic circuits that include electronic components for performing the functionality of one or more instructions, such as a field programmable gate array (FPGA), application specific integrated circuit (ASIC), or other electronic circuits.

Machine-readable storage medium, such as machine-readable storage medium 214, may be any electronic, magnetic, optical, or other storage device that contains or stores executable instructions. Thus, machine-readable storage medium 214 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 214 may be a non-transitory storage medium, where the term “non-transitory” does not encompass transitory propagating indicators. Machine-readable storage medium 214 may be encoded with executable instructions, for example, instructions for storing weights of a neural network model (e.g., neural network model 100) using different amounts of precision.

Memory hardware segments 216 and 226 may each be separate (physical or logical) segments of memory hardware for storing weights of a neural network model. Memory hardware segments 216 and 226 may comprise various types of memory hardware such as a random access memory (RAM), non-volatile RAM (NVRAM), an Electrically Erasable Programmable Read-Only Memory (EEPROM), a storage device, an optical disc, cache and/or other dynamic storage devices. In certain examples (e.g., where computing component 200 is a GPU), memory hardware segment 216 may be implemented on a first streaming multiprocessor (SM) and memory hardware segment 226 may be implemented on a second SM (such SMs are depicted via the dashed lines in FIG. 2). In these examples, one or more of hardware processors 212 may be implemented on the first SM, and one or more of hardware processors 212 may be implemented on the second SM. Relatedly, portions of machine-readable storage medium 214 may be implemented on the first and second SM respectively.

As depicted by the boxes within memory hardware segments 216 and 226, each of memory hardware segments 216 and 226 comprise (physical or logical) sub-segments. Sub-segments of memory hardware segment 216 may comprise a first number of memory bits and sub-segments of memory hardware segment 226 may comprise a second number of memory bits. As visually depicted via the size of the boxes in memory hardware segments 216 and 226 respectively, the first number of memory bits is smaller than the second number of memory bits.

As alluded to above, hardware processors 212 can execute instructions stored in machine-readable storage medium 214 to: (1) responsive to completion of a first set of training iterations for a neural network model, first categorize, according to a heuristic, weights of the neural network model into a first memory block and a second memory block; (2) first store, in memory hardware segment 216, individual weights first-categorized to the first memory block using the first number of memory bits; (3) first store, in memory hardware segment 226, individual weights first-categorized to the second memory block using the second number of memory bits; (4) responsive to completion of a second set of training iterations for the neural network model having the first-stored weights, second categorize, according to the heuristic, the first-stored weights of the neural network model into the first memory block and the second memory block; (5) second store, in memory hardware segment 216, individual weights second-categorized to the first memory block using the first number of memory bits; and (6) second store, in memory hardware segment 226, individual weights second-categorized to the second memory block using the second number of memory bits. As alluded to above, the heuristic may comprise one or more of: (1) a measurement quantifying a magnitude of a respective weight's influence on output of the neural network model during a most recent set of training iterations (weights having relatively higher influence can be represented/stored using the second—i.e., higher-number of memory bits); and (2) a measurement quantifying a magnitude of the respective weight's fluctuations in value during the most recent set of training iterations (weights having relatively smaller fluctuations in value can be represented using the second—i.e., higher/more granular-number of memory bits).

As depicted in FIG. 2, storing individual weights categorized to the first memory block may comprise storing the individual weights categorized to the first memory block in individual (physical or logical) sub-segments of memory hardware segment 216, wherein a respective sub-segment of memory hardware segment 216 comprises the first number of memory bits. Relatedly, storing individual weights categorized to the second memory block may comprise storing the individual weights categorized to the second memory block in individual (physical or logical) sub-segments of memory hardware segment 226, wherein a respective sub-segment of memory hardware segment 226 comprises the second number of memory bits. As alluded to above, in some examples memory hardware segment 216 may be implemented on a first SM of computing component 200 (see e.g., the left box of dashed lines in FIG. 2) and memory hardware segment 226 may be implemented on a second SM of computing component 200 (see e.g., the right box of dashed lines in FIG. 2).

By grouping weights of similar precision in the same (physical or logical) memory unit (i.e., memory hardware segments 216 and 226 respectively), computing component 200 can reduce data latencies associated with moving weights between different memory units at run-time. Relatedly, computing component 200 can improve programming and processing ease/efficiency by having a given (physical or logical) computing unit perform matrix operations involving weights stored with a common precision.

For example, one or more of hardware processors 212 and portions of machine-readable storage medium 214 may be implemented on a first SM of computing component 200 with memory hardware segment 216 (see e.g., the left box of dashed lines in FIG. 2). Relatedly, one or more of hardware processors 212 and portions of machine-readable storage medium 214 may be implemented on a second SM of computing component 200 with memory hardware segment 226 (see e.g., the right box of dashed lines in FIG. 2). The one or more of hardware processors 212 implemented on the first SM may perform intra-memory block matrix operations (i.e., matrix operations involving weights stored within the same memory block/segment of memory hardware) involving weights stored in memory hardware segment 216 using the first number of memory bits. Relatedly, the one or more of hardware processors 212 implemented on the second SM may perform intra-memory block matrix operations involving weights stored in memory hardware segment 226 using the second number of memory bits. Then, responsive to completion of the intra-memory block matrix operations, one or more processors of hardware processors 212 (e.g., one or more central processors) can perform inter-memory block matrix operations (i.e., matrix operations between weights categorized into the first memory block/stored in memory hardware segment 216 and weights categorized into the second memory block/stored in memory hardware segment 226).

This organized sequence of performing matrix operations may be more efficient (i.e., result in less weight movement across units/segments of memory hardware) than an alternative approach that performs matrix operations involving weights stored across different segments of memory hardware and/or different physical computing units in a less organized manner. As alluded to above, improving matrix operation efficiency can improve processing times, and in some case reduce power consumption and monetary costs.

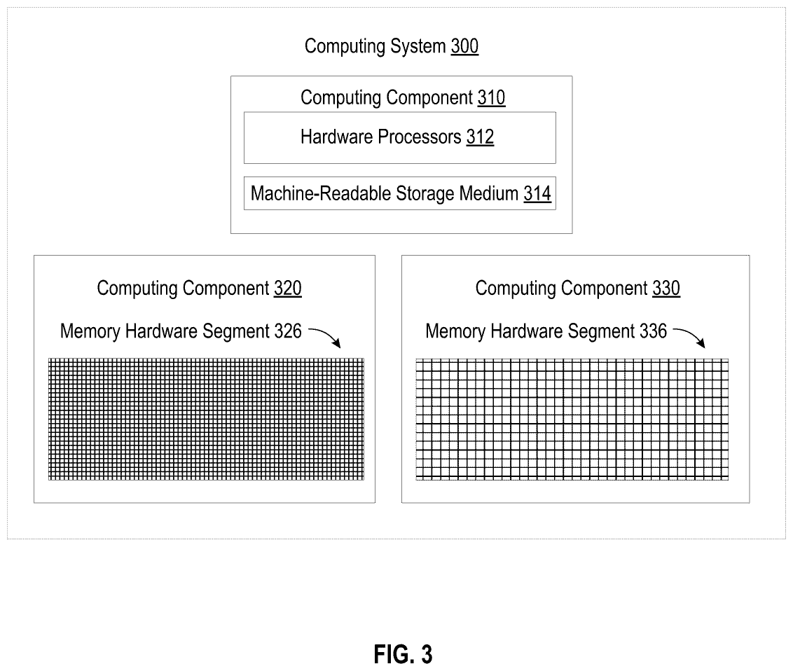

FIG. 3 illustrates an example computing system 300 for storing weights of a neural network model using different amounts of precision, in accordance with various examples of the presently disclosed technology. In certain examples, computing system 300 may be implemented on computing system 102 of FIG. 1.

As depicted, computing system 300 comprises three separate computing components: computing component 310; computing component 320; and computing component 320. In certain implementations, component components 310-330 may comprise separate physical computing units/components. Each of computing components 310-330 may be, for example, a server computer, a controller, a general processing unit (GPU), or any other similar computing component capable of processing and storing data. While not depicted, computing system 300 may include a bus or other communication mechanism for communicating information/data across the different computing components of computing system 300.

As depicted, computing component 310 comprises hardware processors 312 and machine-readable storage medium 314. These components may be the same/similar as hardware processors 212 and machine-readable storage medium 214 described in conjunction with FIG. 2. As depicted, computing component 320 comprises a memory hardware segment 326. As depicted, memory hardware segment 326 may be divided into sub-segments comprising a first number of memory bits. While not depicted, computing component 320 may comprise one or more hardware processors and machine-readable storage medium which can be used to perform matrix operations involving weights of a neural network model stored in memory hardware segment 326.

As depicted, computing component 330 comprises a memory hardware segment 336. As depicted, memory hardware segment 336 may be divided into sub-segments comprising a second number of memory bits, which is larger than the first number of memory bits. While not depicted, computing component 330 may comprise one or more hardware processors and machine-readable storage medium which can be used to perform matrix operations involving weights of a neural network model stored in memory hardware segment 336.

As alluded to above, hardware processors 312 can execute instructions stored in machine-readable storage medium 314 to: (1) responsive to completion of a first set of training iterations for a neural network model, first categorize, according to a heuristic, weights of the neural network model into a first memory block and a second memory block; (2) first store (or cause to first store), in memory hardware segment 326, individual weights first-categorized to the first memory block using the first number of memory bits; (3) first store (or cause to first store), in memory hardware segment 336, individual weights first-categorized to the second memory block using the second number of memory bits; (4) responsive to completion of a second set of training iterations for the neural network model having the first-stored weights, second categorize, according to the heuristic, the first-stored weights of the neural network model into the first memory block and the second memory block; (5) second store (or cause to second store), in memory hardware segment 326, individual weights second-categorized to the first memory block using the first number of memory bits; and (6) second store (or cause to second store), in memory hardware segment 336, individual weights second-categorized to the second memory block using the second number of memory bits. As alluded to above, the heuristic may comprise one or more of: (1) a measurement quantifying a magnitude of a respective weight's influence on output of the neural network model during a most recent set of training iterations (weights having relatively higher influence can be represented/stored using the second—i.e., higher-number of memory bits); and (2) a measurement quantifying a magnitude of the respective weight's fluctuations in value during the most recent set of training iterations (weights having relatively smaller fluctuations in value can be represented using the second—i.e., higher/more granular-number of memory bits).

As depicted in FIG. 3, storing individual weights categorized to the first memory block may comprise storing the individual weights categorized to the first memory block in individual (physical or logical) sub-segments of memory hardware segment 326, wherein a respective sub-segment of memory hardware segment 326 comprises the first number of memory bits. Relatedly, storing individual weights categorized to the second memory block may comprise storing the individual weights categorized to the second memory block in individual (physical or logical) sub-segments of memory hardware segment 336, wherein a respective sub-segment of memory hardware segment 336 comprises the second number of memory bits.

By storing weights with a common precision in the same (e.g., physical) computing component, computing system 300 can reduce data latencies associated with requesting/moving weights across multiple (e.g., physical) computing components at run-time. Relatedly, computing system 300 can improve programming and processing ease/efficiency by having a given (e.g., physical) computing component perform matrix operations involving weights stored with a common precision. For example, Computing component 320 may perform intra-memory block matrix operations (i.e., matrix operations involving weights stored within the same memory block/segment of memory hardware) involving weights stored in memory hardware segment 326 using the first number of memory bits. Relatedly, computing component 330 may perform intra-memory block matrix operations involving weights stored in memory hardware segment 336 using the second number of memory bits. Then, responsive to completion of the intra-memory block matrix operations, computing system 300 (e.g., computing component 310) can perform inter-memory block matrix operations (i.e., matrix operations between weights categorized into the first memory block/stored in memory hardware segment 326 and weights categorized into the second memory block/stored in memory hardware segment 336). This organized sequence of performing matrix operations may be more efficient (i.e., result in less weight movement across computing components) than an alternative approach that performs matrix operations involving weights stored across different computing components in a less organized manner. As alluded to above, improving matrix operation efficiency can improve processing times, and in some case reduce power consumption and monetary costs.

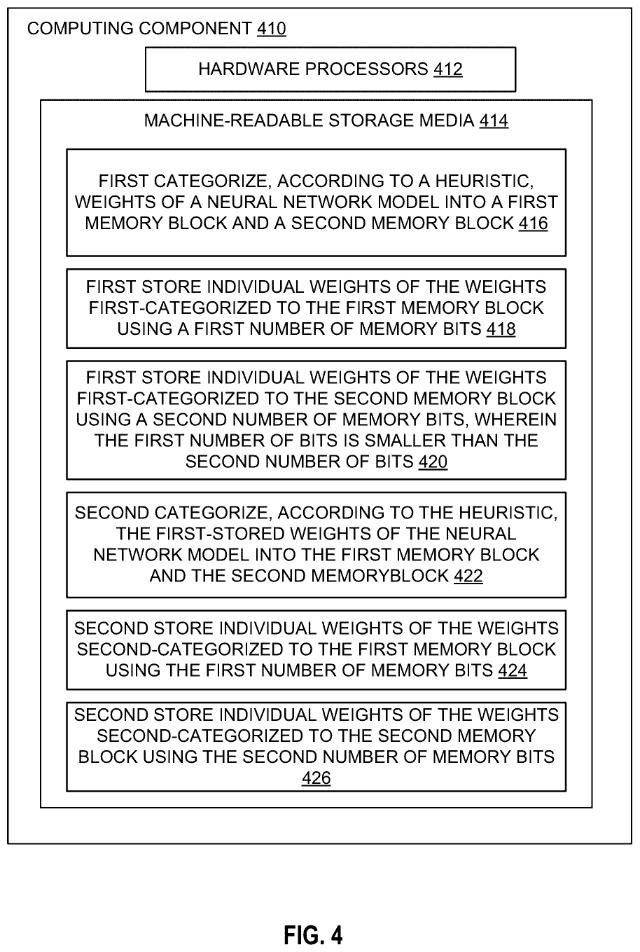

FIG. 4 depicts an example computing component 410 that can be used to dynamically adjust amounts of precision used to represent individual weights of a neural network in response to training, in accordance with various examples of the presently disclosed technology. In certain examples, computing component 410 may be implemented on computing system 102 of FIG. 1, computing component 200 of FIG. 2, computing component 310 of FIG. 3, and/or computing system 300 of FIG. 3.

Referring now to FIG. 4, computing component 410 may be, for example, a server computer, a controller, or any other similar computing component capable of processing data. In the example implementation of FIG. 4, the computing component 410 includes a hardware processor 412, and machine-readable storage medium for 414.

Hardware processor 412 may be one or more central processing units (CPUs), semiconductor-based microprocessors, and/or other hardware devices suitable for retrieval and execution of instructions stored in machine-readable storage medium 414. Hardware processor 412 may fetch, decode, and execute instructions, such as instructions 416-426. As an alternative or in addition to retrieving and executing instructions, hardware processor 412 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 414, may be any electronic, magnetic, optical, or other physical storage device that contains or stores executable instructions. Thus, machine-readable storage medium 414 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 414 may be a non-transitory storage medium, where the term “non-transitory” does not encompass transitory propagating indicators. As described in detail below, machine-readable storage medium 414 may be encoded with executable instructions, for example, instructions 416-426. Further, although the instructions shown in FIG. 4 are in an order, the shown order is not the only order in which the instructions may be executed. Any instruction may be performed in any order, at any time, may be performed repeatedly, and/or may be performed by any suitable device or devices.

Hardware processor 412 can execute instruction 416 to first categorize, according to a heuristic, weights of a neural network model into a first memory block and a second memory block. In various implementations, the first categorizing can be responsive to completion of a first set of training iterations for the neural network model. As alluded to above, the heuristic may comprise at least one of: (1) a measurement quantifying a magnitude of a respective weight's influence on output of the neural network model during a most recent set of training iterations; and (2) a measurement quantifying a magnitude of the respective weight's fluctuations in value during the most recent set of training iterations.

Hardware processor 412 can execute instruction 418 to first store individual weights of the weights first-categorized to the first memory block using a first number of memory bits. Relatedly, hardware processor 412 can execute instruction 420 to first store individual weights of the weights first-categorized to the second memory block using a second number of memory bits, wherein the first number of memory bits is smaller than the second number of memory bits.

As alluded to above, first storing the individual weights of the weights first-categorized to the first memory block using the first number of memory bits may comprise first storing the individual weights of the weights first-categorized to the first memory block in individual sub-segments of a first segment of memory hardware, wherein a respective sub-segment of the first segment of memory hardware comprises the first number of memory bits. Relatedly, first storing the individual weights of the weights first-categorized to the second memory block using the second number of memory bits may comprise first storing the individual weights of the weights first-categorized to the second memory block in individual sub-segments of a second segment of memory hardware, wherein a respective sub-segment of the second segment of memory hardware comprises the second number of memory bits. In certain implementations, the first segment of memory hardware may be implemented on a first streaming multiprocessor (SM) of a general processing unit (GPU) and the second segment of memory hardware may be implemented on a second SM of the GPU. In other implementations, the first segment of memory hardware may be implemented on a first GPU and the second segment of memory hardware may be implemented on a second GPU.

Hardware processor 412 can execute instruction 422 to second categorize, according to the heuristic, the first-stored weights of the neural network model into the first memory block and the second memory block. In various implementations, the second categorizing can be responsive to completion of a second set of training iterations for the neural network model having the first-stored weights.

Hardware processor 412 can execute instruction 424 to second store individual weights of the weights second-categorized to the first memory block using the first number of memory bits. Relatedly, hardware processor 412 can execute instruction 426 to second store individual weights of the weights second-categorized to the second memory block using the second number of memory bits.

In certain implementations, hardware processor 412 can execute a further instruction to, during the second set of training iterations: (a) perform intra-memory block matrix operations between the weights first-categorized into the first memory block; (b) perform intra-memory block matrix operations between the weights first-categorized into the second memory block; and (c) responsive to completion of the intra-memory block matrix operations, perform inter-memory block matrix operations between the weights first-categorized into the first memory block and the weights first-categorized into the second memory block.

In some implementations, prior to the first set of training iterations for the neural network model, hardware processor 412 can execute a further instruction to: (a) initially categorize all weights of the neural network model into the first memory block; and (b) initially store individual weights of the weights initially-categorized to the first memory block using the first number of memory bits such that the neural network model has the initially-stored weights during the first set of training iterations.

In various implementations, the first categorizing may further comprise, first categorizing, according to the heuristic, weights of the neural network model into a third memory block. In these implementations, the first storing may further comprise, first storing individual weights of the weights first-categorized to the third memory block using a third number of memory bits, wherein the second number of memory bits is smaller than the third number of memory bits. Relatedly, the second categorizing may further comprise, second categorizing, according to the heuristic, weights of the neural network model into the third memory block. Here, the second storing may further comprise, second storing individual weights of the weights second-categorized to the third memory block using the third number of memory bits.

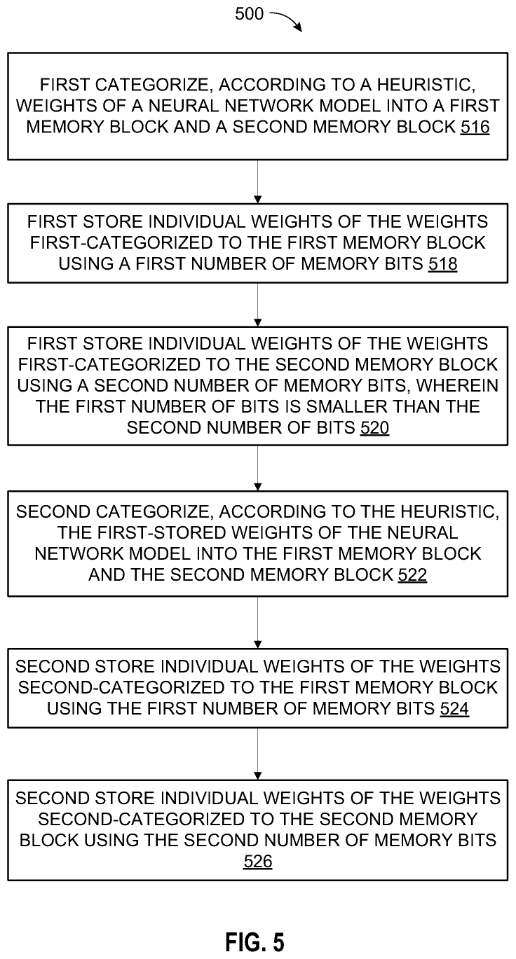

FIG. 5 depicts an example flow diagram 500 that can be used to dynamically adjust amounts of precision used to represent individual weights of a neural network in response to training, in accordance with one or more examples.

As depicted, flow diagram 500 includes operations 516-526. As these operations accord with instructions 416-426 of FIG. 4, they will not be described again for brevity. Operations 516-526 may be performed by any one of computing system 102 of FIG. 1, computing component 200 of FIG. 2, computing component 310 of FIG. 3, computing system 300 of FIG. 3, and computing component 410 of FIG. 5.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
first categorizing, according to a heuristic, weights of a neural network model into a first memory block and a second memory block;
first storing individual weights of the weights first-categorized to the first memory block using a first number of memory bits;
first storing individual weights of the weights first-categorized to the second memory block using a second number of memory bits, wherein the first number of memory bits is smaller than the second number of memory bits;
second categorizing, according to the heuristic, the first-stored weights of the neural network model into the first memory block and the second memory block;
second storing individual weights of the weights second-categorized to the first memory block using the first number of memory bits; and
second storing individual weights of the weights second-categorized to the second memory block using the second number of memory bits.

2. The method of claim 1, wherein:
the first categorizing is responsive to completion of a first set of training iterations for the neural network model; and
the second categorizing is responsive to completion of a second set of training iterations for the neural network model.

3. The method of claim 1, wherein the heuristic comprises at least one of:
a measurement quantifying a magnitude of a respective weight's influence on output of the neural network model during a most recent set of training iterations; and
a measurement quantifying a magnitude of a respective weight's fluctuations in value during the most recent set of training iterations.

4. The method of claim 2, further comprising, during the second set of training iterations:
performing intra-memory block matrix operations between the weights first-categorized into the first memory block;
performing intra-memory block matrix operations between the weights first-categorized into the second memory block; and
responsive to completion of the intra-memory block matrix operations, performing inter-memory block matrix operations between the weights first-categorized into the first memory block and the weights first-categorized into the second memory block.

5. The method of claim 1, wherein:
the first storing the individual weights first-categorized to the first memory block using the first number of memory bits comprises first storing the individual weights first-categorized to the first memory block in individual sub-segments of a first segment of memory hardware, wherein a respective sub-segment of the first segment of memory hardware comprises the first number of memory bits; and
the first storing the individual weights first-categorized to the second memory block using the second number of memory bits comprises first storing the individual weights first-categorized to the second memory block in individual sub-segments of a second segment of memory hardware, wherein a respective sub-segment of the second segment of memory hardware comprises the second number of memory bits.

6. The method of claim 5, wherein:
the first segment of memory hardware is implemented on a first streaming multiprocessor (SM) of a processing unit; and
the second segment of memory hardware is implemented on a second SM of the processing unit.

7. The method of claim 2, further comprising:
prior to the first set of training iterations for the neural network model, initially categorizing all weights of the neural network model into the first memory block; and
initially storing individual weights of the weights initially-categorized to the first memory block using the first number of memory bits such that the neural network model has the initially-stored weights during the first set of training iterations.

8. The method of claim 1, wherein:
the first categorizing further comprises, first categorizing, according to the heuristic, weights of the neural network model into a third memory block;
the first storing further comprises, first storing individual weights of the weights first-categorized to the third memory block using a third number of memory bits, wherein the second number of memory bits is smaller than the third number of memory bits;
the second categorizing further comprises, second categorizing, according to the heuristic, weights of the neural network model into the third memory block; and
the second storing further comprises, second storing individual weights of the weights second-categorized to the third memory block using the third number of memory bits.

9. A system comprising:
a first segment of memory hardware;
a second segment of memory hardware; and
one or more processors operative to execute machine-readable instructions to:
first categorize, according to a heuristic, weights of a neural network model into a first memory block and a second memory block;
first store, in the first segment of memory hardware, individual weights of the weights first-categorized to the first memory block using a first number of memory bits;
first store, in the second segment of memory hardware, individual weights of the weights first-categorized to the second memory block using a second number of memory bits, wherein the first number of memory bits is smaller than the second number of memory bits;
second categorize, according to the heuristic, the first-stored weights of the neural network model into the first memory block and the second memory block;
second store, in the first segment of memory hardware, individual weights of the weights second-categorized to the first memory block using the first number of memory bits; and
second store, in the second segment of memory hardware, individual weights of the weights second-categorized to the second memory block using the second number of memory bits.

10. The system of claim 9, wherein:
the first categorizing is responsive to completion of a first set of training iterations for the neural network model; and
the second categorizing is responsive to completion of a second set of training iterations for the neural network model.

11. The system of claim 9, wherein the heuristic comprises at least one of:
a measurement quantifying a magnitude of a respective weight's influence on output of the neural network model during a most recent set of training iterations; and
a measurement quantifying a magnitude of a respective weight's fluctuations in value during the most recent set of training iterations.

12. The system of claim 10, wherein the one or more processors are further operative to execute machine-readable instructions to, during the second set of training iterations:
perform intra-memory block matrix operations between the weights first-categorized into the first memory block;
perform intra-memory block matrix operations between the weights first-categorized into the second memory block; and
responsive to completion of the intra-memory block matrix operations, perform inter-memory block matrix operations between the weights first-categorized into the first memory block and the weights first-categorized into the second memory block.

13. The system of claim 9, wherein:
the first storing, in the first segment of memory hardware, the individual weights of the weights first-categorized to the first memory block comprises first storing, in individual sub-segments of the first segment of memory hardware, the individual weights of the weights first-categorized to the first memory block, wherein a respective sub-segment of the first segment of memory hardware comprises the first number of memory bits; and
the first storing, in the second segment of memory hardware, the individual weights of the weights first-categorized to the second memory block comprises first storing, in individual sub-segments of the second segment of memory hardware, the individual weights of the weights first-categorized to the second memory block, wherein a respective sub-segment of the second segment of memory hardware comprises the second number of memory bits.

14. The system of claim 9, further comprising a processing unit, wherein:
the first segment of memory hardware is implemented on a first streaming multiprocessor (SM) of the processing unit; and
the second segment of memory hardware is implemented on a second SM of the processing unit.

15. The system of claim 9, further comprising a first processing unit and a second processing unit, wherein:
the first segment of memory hardware is implemented on the first processing unit; and
the second segment of memory hardware is implemented the second processing unit.

16. The system of claim 10, wherein the one or more processors are further operative to execute machine-readable instructions to:
prior to the first set of training iterations for the neural network model, initially categorize all weights of the neural network model into the first memory block; and
initially store, in the first segment of memory hardware, individual weights of the weights initially-categorized to the first memory block using the first number of memory bits such that the neural network model has the initially-stored weights during the first set of training iterations.

17. Non-transitory computer-readable medium storing instructions, which when executed by one or more processors, cause the one or more one or more processors to:
responsive to completion of a first set of training iterations for a neural network model, first categorize, according to a heuristic, weights of the neural network model into a first memory block and a second memory block;
first store individual weights of the weights first-categorized to the first memory block using a first number of memory bits;
first store individual weights of the weights first-categorized to the second memory block using a second number of memory bits, wherein the first number of memory bits is smaller than the second number of memory bits;
responsive to completion of a second set of training iterations for the neural network model having the first-stored weights, second categorize, according to the heuristic, the first-stored weights of the neural network model into the first memory block and the second memory block;
second store individual weights of the weights second-categorized to the first memory block using the first number of memory bits; and
second store individual weights of the weights second-categorized to the second memory block using the second number of memory bits.

18. The non-transitory computer-readable medium storing instructions of claim 17, wherein the heuristic comprises at least one of:
a measurement quantifying a magnitude of a respective weight's influence on output of the neural network model during a most recent set of training iterations; and
a measurement quantifying a magnitude of a respective weight's fluctuations in value during the most recent set of training iterations.

19. The non-transitory computer-readable medium storing instructions of claim 17, further comprising an instruction to, during the second set of training iterations:
perform intra-memory block matrix operations between the weights first-categorized into the first memory block;
perform intra-memory block matrix operations between the weights first-categorized into the second memory block; and
responsive to completion of the intra-memory block matrix operations, perform inter-memory block matrix operations between the weights first-categorized into the first memory block and the weights first-categorized into the second memory block.

20. The non-transitory computer-readable medium storing instructions of claim 15, wherein:
the first storing the individual weights of the weights first-categorized to the first memory block comprises first storing the individual weights of the weights first-categorized to the first memory block in individual physical sub-segments of a first physical segment of memory hardware, wherein a respective physical sub-segment of the first physical segment of memory hardware comprises the first number of memory bits; and
the first storing the individual weights of the weights first-categorized to the second memory block comprises first storing the individual weights of the weights first-categorized to the second memory block in individual physical sub-segments of a second physical segment of memory hardware, wherein a respective physical sub-segment of the second physical segment of memory hardware comprises the second number of memory bits.
